(19) United States
(12) Patent Application Publication
(10) Pub. No.: US 2003/0124276 A1
(43) Pub. Date: Jul. 3, 2003

(54) Protection member received in crystal spheres

(76) Inventor: Zone-Wing Tseng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/026,789

(22) Filed: Dec. 27, 2001

(51) Int. Cl. B32B 3/10

(52) U.S. Cl. 428/34.1; 428/138

(57) ABSTRACT

A protection member engaged with a hole in an outer surface of a crystal sphere is made of plastic material and includes a circumference portion which is attached to an inner surface of a hole in the crystal sphere. A central ring is located in a center of the circumference portion and a mediate layer is connected between the central ring and the circumference portion. The mediate layer includes at least one flexible protrusion which faces the center of the crystal sphere and the at least one flexible portion is deformed to absorb the expansion of the stuff when the temperature is increased.

### FIELD OF THE INVENTION

The present invention relates to a protection member that has a plurality of flexible protrusions which faces the center of a crystal sphere. The protrusions are deformed to absorb the expanding volume of stuff in the sphere to prevent the crystal sphere from being cracked.

### BACKGROUND OF THE INVENTION

Crystal spheres include two main types one of which is a solid crystal sphere and the other has stuff in the center of the crystal sphere. The solid crystal sphere has minor reaction to the temperature differences so that the crystal sphere is not damaged when a huge temperature difference is occurred. On the contrary, the crystal spheres that have stuff in the center thereof are sensitive to the temperature change. When the temperature rises, the stuff in the crystal spheres is expanded and could break out the sealing portion of the crystal spheres.

The present invention intends to provide a protection member that is received in the crystal sphere and can absorb the expansion of the stuff so as to protect the crystal sphere.

### SUMMARY OF THE INVENTION

In accordance with one aspect of the present invention, there is provided a protection member engaged with a hole in defined in an outer inner surface of crystal sphere. The protection member comprises a circumference portion, a central ring located in a center of the circumference portion and a mediate layer connected between the central ring and the circumference portion. The mediate layer includes at least one flexible protrusion facing the center of the crystal sphere.

The primary object of the present invention is to provide a protection member used in a stuff-type crystal sphere and the protection member has flexible protrusions that absorb expansion of the stuff.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a plane view to show the protection member of the present invention;

FIG. 2 is a cross sectional view to show a section of the protection member of the present invention, and

FIG. 3 shows the protection member of the present invention received in a crystal sphere.

### DETAILED DESCRIPTION OF THE PREFERRED EMBODIMENT

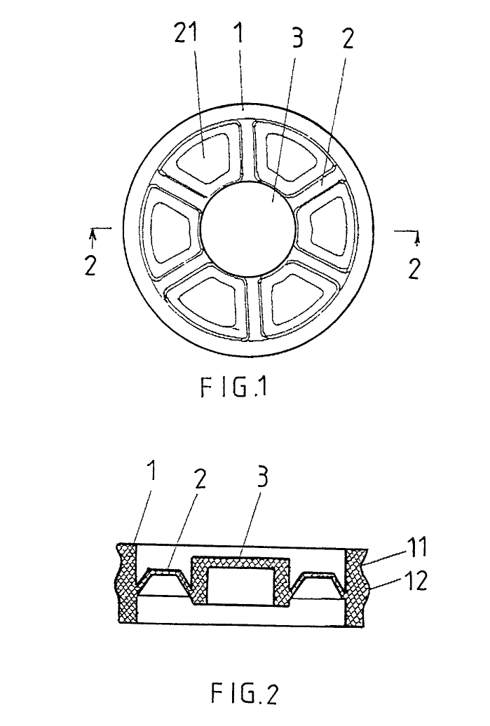

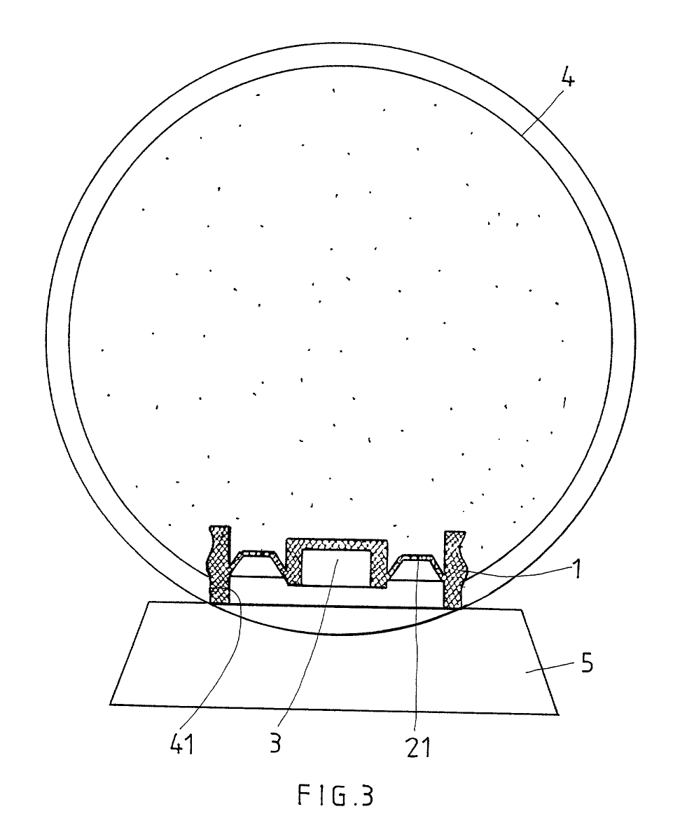

Referring to FIGS. 1 to 3, the protection member of the present invention is made of plastic material and comprises a circumference portion 1 and a central ring 3 is located in a center of the circumference portion 1 and a mediate layer 2 is connected between the central ring 3 and the circumference portion 1. The mediate layer 2 includes at least one flexible protrusion 21 which faces a center of the crystal sphere 4. A plurality of ridges 12 and grooves 11 are defined in an outer surface of the circumference portion 1.

When using the protection member, the crystal sphere 4 has stuff filled therein and a hole 41 is defined in an outer surface of the crystal sphere 4. The protection member is engaged with the hole 41 and the ridges 12 and the grooves 11 seal the hole 41. The ridges 12 and the grooves 11 seal the sealing portion of the crystal sphere.

When the temperature rises, the stuff in the crystal sphere is expanded and the expansion presses the flexible protrusions 21. The flexible protrusions 21 are deformed and absorb the pressure so as to stop the pressure reaching the crystal sphere and the hole 41 of the crystal sphere 4 can be protected.

The crystal sphere 4 is put on a base 5 and the protection member is arranged to face the base 5 so that the protection cannot be seen.

While we have shown and described the embodiment in accordance with the present invention, it should be clear to those skilled in the art that further embodiments may be made without departing from the scope of the present invention.

What is claimed is:

1. A protection member engaged with a hole defined in an outer surface of crystal spheres, comprising:
a circumference portion which is adapted to be engaged with the hole, and
a central ring located in a center of the circumference portion and a mediate layer connected between the central ring and the circumference portion, the mediate layer including at least one flexible protrusion.

2. The protection member as claimed in claim 1 further comprising ridges and grooves on an outer surface of the circumference portion.
